(19) United States
(12) Patent Application Publication
(10) Pub. No.: US 2006/0031544 A1
(43) Pub. Date: Feb. 9, 2006

(54) Device server access using a data-type aware markup language

(75) Inventor: Adam D. Dirstine, Rochester, MN (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Digi International Inc.

(21) Appl. No.: 10/873,051

(22) Filed: Jun. 22, 2004

(51) Int. Cl. G06F 15/16

(52) U.S. Cl. 709/230

(57) ABSTRACT

A method of managing devices on a client/server computer network that comprises providing a transport protocol layer to transfer data among the devices, providing a request and response protocol layer implemented using a data-type aware general markup language, and transferring device management information to and from the devices using the transport protocol layer and the request and response protocol layer.

### TECHNICAL FIELD

This document relates generally to networked computer systems and in particular to managing devices using a device server in communication with the network.

### BACKGROUND

Networked systems include device servers in communication with a variety of different types of devices. The network allows the devices to be managed remotely from a client through communication with the server or servers. To manage the devices, device servers are configured to accommodate the various device types. As the number of different types of devices connected through networks increases, configuring networks can quickly become complicated as network connectivity grows.

Some methods involve interactively sending commands to the device server, such as by telnet for example. Other methods of configuring device servers include using configuration files that have a nonhuman readable format (e.g. a binary format). Using a nonhuman readable file reduces the ability of a user to determine what is configured on the server. Use of a nonhuman readable file also complicates debugging of the server configuration. Other methods involve sending configuration files in hyper-text markup language (HTML) format.

The contents of configuration files depend on what devices are connected to the network (i.e. what need to be configured), and the files need to be customized for a current network configuration. This requires a programmer to be familiar with all the nuances of protocols of the various devices on the network. It also requires the configuration file to be changed when the configuration of the managed devices changes. Because every device type has a custom configuration mechanism, it is tedious and difficult to change a configuration file whenever a configuration of the managed devices changes. It is desirable to configure device servers on a network by a method that is flexible and easy to use.

### SUMMARY

This document describes both devices and methods used to manage devices on a computer network. One method example comprises providing a transport protocol layer to transfer data among the devices, providing a request and response protocol layer implemented using a data-type aware general markup language, and transferring device management information to and from the devices using the transport protocol layer and the request and response protocol layer.

One device example includes at least one processor and a network interface to communicate with the at least one processor and a network using a transport protocol layer. The device also includes a request and response protocol application used to exchange device management information with the at least one processor and a remote device. The request and response protocol includes at least one layer implemented using a data-type aware general markup language.

### BRIEF DESCRIPTION OF THE DRAWINGS

FIG. 1 shows a representation of a multilayer protocol.

FIG. 2 is a block diagram of a method of managing devices on a client/server computer network.

FIG. 3 is an illustration of an embodiment of a network device that uses a multilayer protocol.

### DETAILED DESCRIPTION

In the following detailed description, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

This document discusses, among other things, methods for managing devices on a computer network. The devices are managed by a client through a device server. The device server may or may not be embedded in the managed device. A client exchanges information with the device server to perform device management functions such as device initialization, querying the device status and settings, and writing the device settings. The device server then writes or queries the device to be managed. To avoid the previously mentioned difficulties in configuring device servers, a client and device server exchange device management information using a data-type aware general markup language. This method allows a programmer to quickly build applications by using the benefits of the industry standards of the data-type aware markup language such as by taking advantage of off-the-shelf parsers, self-describing data, standard formats, and human readability. Also, a data-type aware markup language is human-readable. This eliminates the process of decoding a nonhuman-readable language when debugging a server configuration.

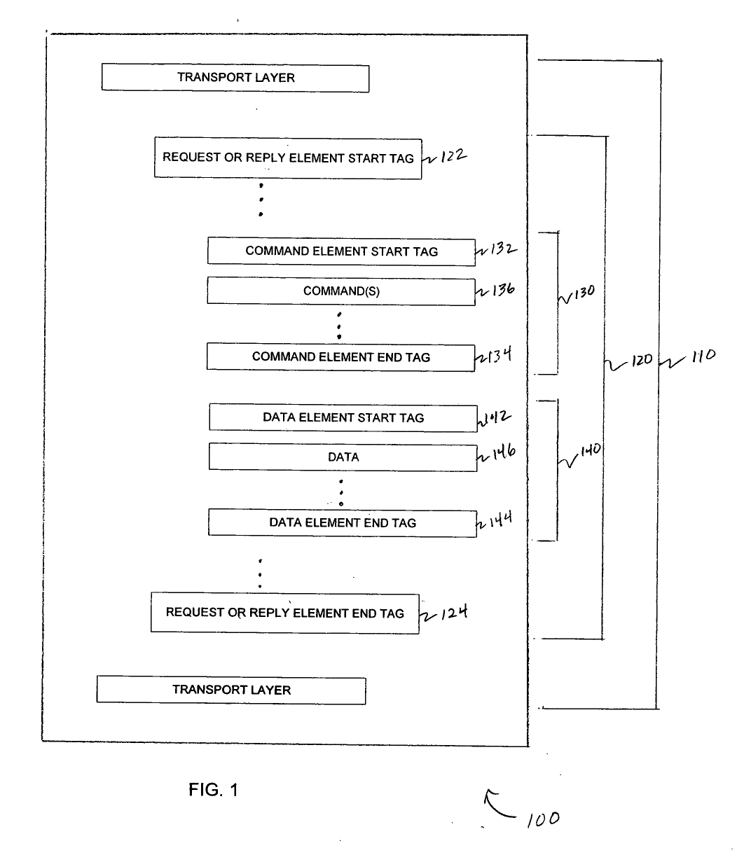

The client and the device server exchange information using a multilayer protocol. FIG. 1 shows a representation of a multilayer protocol 100. The first layer is referred to as a transport protocol layer 110. The transport protocol layer 110 is the basic mechanism that a client and a device server use to communicate. The transport protocol layer 110 specifies the initialization process, the sending and responding process, the closing process, the error recovery process, and the network security. The exchanged information includes configuration information, control information and status information. The transport protocol is any computer to computer communication protocol. This includes protocols such as TFTP, FTP, telnet, HTTP, HTTPS, stream sockets, datagram sockets, serial communication protocols, and the like. Requests are sent to the managed device that identify that the request is in the multilayer protocol 100 format.

In one embodiment, a transport protocol layer 110 is implemented using a protocol compatible with a web interface, such as, for example, standard hypertext transfer protocol (HTTP). In the embodiment, requests sent to the device include a uniform resource identifier (URI) to identify that the request is in the multilayer protocol 100 format. For example, if the URI is UE/rci and the IP address is 192.168.1.1, then the protocol requests would be sent to address http://192.168.1.1/UE/rci, and the address identifies that the request is in the multilayer protocol 100 format. If the device has limitations on the size of a message it can receive, the request may be broken up into multiple requests. For example, some devices may require that requests longer than the device's buffer size be broken up into multiple requests that are less than or equal to the size of the buffer. Generally, replies from the devices do not need to be broken up into smaller replies.

Network security and any errors that occur in the transport protocol are handled through the transport protocol layer 110. In one embodiment of a transport protocol layer 110 that uses standard HTTP, network security is handled by passing a username and password to the device in the header of each HTTP request. Standard HTTP errors are returned for HTTP related problems. For example, clients may be programmed to handle HTTP errors such as “buffer too large” errors.

Embodiments where the transport protocol layer 110 is implemented using a serial communication protocol are useful where a master processor, used to configure a network, is connected to a device server through a serial port. One example of a serial communication protocol is the RS232 protocol. Use of a serial communication protocol allows the master processor to configure a device server as part of the master processor's configuration process, eliminating the need for a separate, manual configuration step. Typically, the device server must be placed in configuration mode to accept subsequent layers of the multilayer protocol 100.

The second layer of the multilayer protocol 100 is a request and response protocol layer 120. The request and response protocol layer 120 is implemented using a data-type aware general markup language such as, for example, the extensible markup language (XML). In the request and response protocol layer 120, request messages cause some action to be executed by the device server and response or reply messages are the results of the action performed. For example, if the request and response protocol layer 120 is implemented with XML, then the exchanged information can be viewed as an XML document of a specific format “encapsulated” within the bi-directional transport protocol layer 110.

The request and reply messages are transferred as data elements with an identifier to identify the type of data being transferred. In one embodiment, the identifier includes a request or a reply element start tag 122 and a request or a reply element end tag 124. For example, a request element may contain a markup language element such as simply “request” to identify the start or end of the request, and a reply element may contain a markup language element such as simply “reply” to identify the start or end of the reply. It is useful if the elements are more descriptive. For example, elements such as “rci_request” or “rci_reply” describe the type of request or reply message being sent. In another embodiment, the request element contains a version number of the multilayer protocol 100 (e.g. “request version=1.1”). This solves the problem of communicating with device servers that have different multilayer protocol 100 versions. In the embodiment, a reply from a device server also contains a version number (e.g. reply version=“1.1”). Using a version number is also useful if the client code is not written to be version independent. If the client code is not written to be version independent, the request elements supply the version of the multilayer protocol 100.

Errors that occur in the request and response protocol layer 120 result in error and/or warning sub-elements being sent in a reply element. Table 1 gives some examples of errors that may be returned in a reply element.

TABLE 1

| Error ID | Description |
|---|---|
| 1 | Request not valid Markup Language |
| 2 | Request not recognized |
| 3 | Unknown command |

As stated above, request messages cause some action to be executed by the device server and reply messages include the results of the action performed. In some embodiments, the multilayer protocol 100 includes a third layer that includes command sub-elements 130 as part of request and reply elements. In one version of the embodiments, the command sub-elements 130 include a start tag 132 and an end tag 134. The command sub-elements 130 include commands 136 to indicate an action requested, or an action performed if the command sub-element 130 is part of a reply element. Table 2 gives some examples of commands.

TABLE 2

| | REQUEST | RESPONSE |
|---|---|---|
| COMMAND | DESCRIPTION | DESCRIPTION |
| query_setting | Request for | Returns requested |
| | device settings. | configuration settings. |
| set_setting | Set settings specified | Empty setting groups in |
| | in setting element. | reply indicate success. |
| | Settings data required. | |
| query_state | Request current | Returns requested |
| | device state such | state. |
| | as statistics and | |
| | status. Sub-element | |
| | may be supplied to | |
| | provide subset results. | |
| set_factory_default | Sets device settings to | Empty setting |
| | factory defaults. | groups in reply |
| | | indicate success. |
| reboot | Reboots device. | |

Examples or request elements containing command sub-elements are given below. The first example requests retrieval of all configuration settings.

| <request version=“1.1”> | | (Identifies the protocol and that this is a |
|---|---|---|
| | | request) |
| | <query_setting/> | (requests configuration settings of the device) |

</request>

In the example, the request and command comprise XML documents. The second example requests the configuration information for just boot settings and serial settings.

<request version=“1.1”>

<query_setting>

| | |
|---|---|
| <boot/> | (requests boot settings of the device) |
| <serial/> | (requests serial settings of the device) |

</query_setting>

</request>

In other embodiments, the third layer of the multilayer protocol 100 includes data sub-elements 140 as part of request and reply elements. In one version of the embodiments, the data sub-elements 140 include a start tag 142 and an end tag 144. The data sub-elements 140 may contain data 146 about device settings and device state. For example, the data sub-elements 140 may have the form:

<data_group>

<field>value</field>

<data_group> ,

where “data_group” is used as a start tag and end tag to indicate a grouping of related fields (e.g. “serial” for serial port settings), “field” are names or types of individual settings (e.g. “baud”), and “value” is the value associated with the field.

The data sub-elements 140 are expressed in a data-type aware markup language. In one embodiment, the data sub-elements 140 include at least two types: setting and state. Setting data sub-elements 140 are useful for communicating device setting and control information. The setting data may be read/write, read-only, or write-only (write-only is typically only used for password data). State data sub-elements are useful to retrieve device statistics or other device information. State data is typically read-only.

Some embodiments of data sub-elements 140 are intended for serial port control, configuration and status (e.g. a four serial port device will have four serial setting elements). A specific port may identified in the sub-element as an attribute. In one embodiment, the attribute has the form:
index=“num”,

where “index” specifies a serial port attribute and “num” is an integer to specify which serial port. In another embodiment, a default value may used when a data sub-element 140 is specified without an explicit port attribute, such as “1” for example. An example of a reply element returning a serial setting data sub-element 140 indicating that the baud rate is set to “300” in serial port “2” is shown below:

<reply version=“1.1”>

<query_setting>

<serial index=“2”>

<baud>300</baud>

</serial>

</reply> .

Note that the elements and sub-elements are easily readable, but are generally verbose in comparison to a custom binary format.

Some embodiments of reply elements include child sub-elements in the command sub-element 130 or data sub-element 140 where the child sub-elements indicate the result of the request element communication. Usually, the child sub-elements include error and/or warning indications. A warning differs from an error in that the command still executes but a warning is returned. In one embodiment, the errors and/or warnings are identified by attributes that include an identifier or ID attribute, and optionally, a description attribute and a hint attribute.

The ID attribute is a numeric identifier specified in the command or data sub-element to identify the error or warning that occurred. An error or warning ID attribute of zero indicates no error or warning occurred. The optional description attribute is a text description of the error or warning. The optional hint attribute indicates the source of the error to the client. Typically, the hint attribute is set to the field name of the setting for the error or warning. In one embodiment, an ID attribute is required in the sub-element while the description and hint attributes are optional. Multiple description and hint attributes may be included. An example of an error in setting a baud rate of a serial port is shown below:

<serial_setting>

<error id=“3”>

<hint>baud</hint>
<desc>Value out of valid range.</desc>

</error>

</serial_setting> .

Note that a reply message layer is not shown.

Several examples of elements of a multilayer protocol are shown above. It will be understood to one of ordinary skill in the art upon reading this detailed description that other formats for commands, data and error handling elements are possible and can be used without departing from the scope of this document.

A data-type aware markup language is extensible. Because the multilayer protocol 100 is implemented using a data-type aware markup language, an application does not need to know an exact format of a configuration file for a managed device. For example, the device servers recognize that commands come after requests, that data groups come after commands, and fields come after data groups. Because the data is self-described, applications can manipulate request and reply messages for current and future devices without having to know the exact meaning of the data. Further, the messages are easily interpreted. The requests and replies can be manipulated by applications that are not custom-made for this purpose. For example, a developer can view, interpret, and understand reply messages using Internet Explorer®.

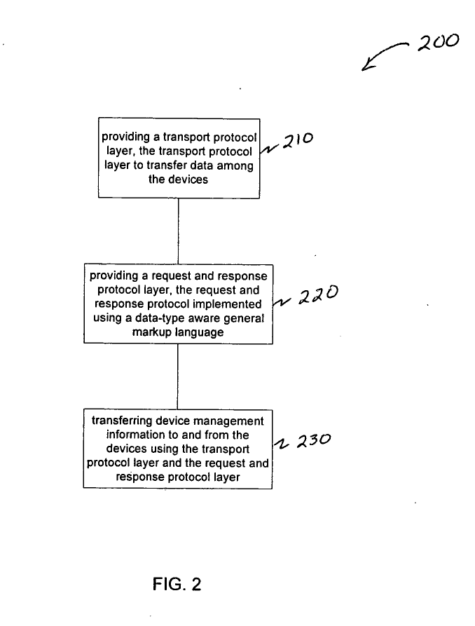

FIG. 2 is a block diagram 200 of a method of managing devices on a client/server computer network. At 210, a transport protocol layer is provided, where the transfer protocol layer transfers data among the devices. At 220, a request and response protocol layer is provided, where the request and response protocol layer is implemented using a data type aware general markup language. At 230, device management information is transferred to and from the devices using the transport protocol layer and the request and response protocol layer. In the method, the transfer protocol layer and the request and response protocol layer are implemented by any of the embodiments discussed previously.

In other embodiments, the transport protocol layer and the request and response protocol layer are provided on a computer readable medium such as a CD-ROM to be installed on a device server. The request and response protocol layer includes request and reply elements expressed in the data-type aware markup language. In one such embodiment, the medium includes a command module. The command module includes at least one command expressed as a sub-element of the request and reply elements. The command specifies an action to be executed by the device server. In another embodiment, the medium further includes a data module, the data module including data structures expressed as data elements of a data-type aware markup language.

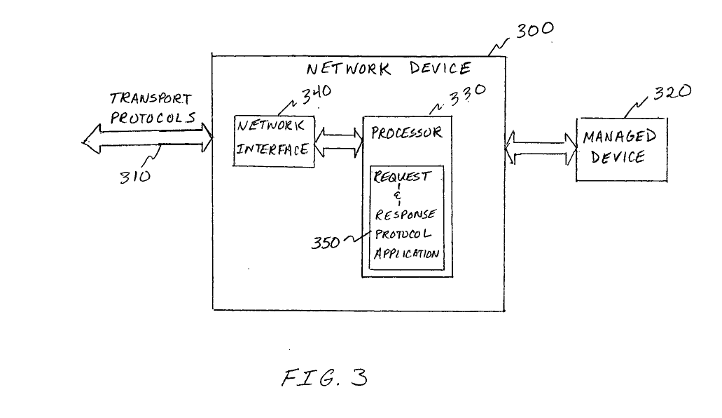

FIG. 3 is an illustration of an embodiment of a network device 300 that uses a multilayer protocol. The multilayer protocol is used to communicate over a network 310 to manage at least one device 320. The network device 300 includes at least one processor 330 and a network interface 340 to communicate with the at least one processor 330 and the network 310 using a transport protocol layer. In one embodiment, the network interface 340 is a web interface and the transport protocol layer includes HTTP. In another embodiment, the network interface 340 is a serial port and the transport protocol layer includes a serial communication protocol. The network device 300 also includes a request and response protocol application 350 used to exchange device management information with the at least one processor 330 and a remote device (not shown) over the network 310. The management information includes information to configure managed devices 320, to control managed devices 320 and retrieve status information from managed devices 320. The request and response protocol layer includes at least one protocol layer implemented using a data-type aware markup language. In one embodiment, the data-type aware markup language is XML. In another embodiment, the request and response layer includes a plurality of layers including a command layer and data layer, the command and data layers implemented as elements expressed in the data-type aware markup language.

Although specific examples have been illustrated and described herein, it will be appreciated by those of ordinary skill in the art that any arrangement calculated to achieve the same purpose could be substituted for the specific example shown. This application is intended to cover any adaptations or variations of the present invention. Therefore, it is intended that this invention be limited only by the claims and the equivalents shown.

What is claimed is:

1. A method of managing devices on a client/server computer network, the method comprising:
providing a transport protocol layer, the transport protocol layer to transfer data among the devices;
providing a request and response protocol layer, the request and response protocol layer implemented using a data-type aware general markup language; and
transferring device management information to and from the devices using the transport protocol layer and the request and response protocol layer.

2. The method of claim 1, wherein the request and response protocol layer includes request elements and reply elements, the request and reply elements expressed using a data-type aware general markup language.

3. The method of claim 3, wherein the reply elements include error and/or warning elements.

4. The method of claim 2, wherein the request and response layer includes a command layer, the command layer including commands expressed as sub-elements of the request and reply elements using a data-type aware general markup language.

5. The method of claim 1, wherein the request and response protocol layer includes a data layer, the data layer including data elements expressed using a data-type aware general markup language.

6. The method of claim 1, wherein the data-type aware general markup language includes extensible markup language (XML).

7. The method of claim 1, wherein the transport protocol layer is compatible with a web interface.

8. The method of claim 1, wherein the transport protocol layer includes a serial communication protocol.

9. The method of claim 1, wherein transferring device management information includes configuring devices.

10. The method of claim 1, wherein transferring device management information includes controlling devices.

11. The method of claim 1, wherein transferring device management information includes transferring device status information.

12. A network device, comprising:
at least one processor;
a network interface to communicate with the at least one processor and a network using a transport protocol layer; and
a request and response protocol application to exchange device management information with the at least one processor and a remote device, wherein the request and response protocol includes at least one layer implemented using a data-type aware general markup language.

13. The network device of claim 12, wherein the request and response protocol includes request elements and reply elements, the request and reply elements both expressed in the data-type aware general markup language.

14. The network device of claim 13, wherein the request elements and reply elements configure managed devices.

15. The network device of claim 13, wherein the request elements and reply elements control managed devices.

16. The network device of claim 13, wherein the request elements and reply elements request and return status information from managed devices.

17. The network device of claim 12, wherein the request and response protocol includes a plurality of layers including a command layer and data layer, the command and data layers implemented as elements expressed in the data-type aware general markup language.

18. The network device of claim 12, wherein the transport protocol layer is compatible with a web interface.

19. The network device of claim 12, wherein the transport protocol layer includes a serial communication protocol.

20. The network device of claim 12, wherein the data-type aware general markup language includes extensible markup language (XML).

21. A computer readable medium to implement a method of transferring device management information to and from remote devices on a network, the computer readable medium comprising:
a transport protocol layer module, the transport protocol layer module to implement a network communication protocol; and
a request and response protocol layer module expressed as request and reply elements using a data-type aware general markup language, the request and response protocol layer to provide information to manage devices on the network.

22. The computer readable medium of claim 21, wherein the medium further includes a command module, the command module including at least one command expressed as a sub-element of the request and reply elements using a data-type aware general markup language, wherein the at least one command specifies a device action.

23. The computer readable medium of claim 21, wherein the medium further includes a data module, the data module including data structures expressed as data elements of a data-type aware general markup language.

24. The computer readable medium of claim 21, wherein the data-type aware general markup language includes extensible markup language (XML).
